(19) United States
(12) Patent Application Publication
(10) Pub. No.: US 2025/0348097 A1
(43) Pub. Date: Nov. 13, 2025

(54) CONTROL LOOP SUB-SYSTEM VOLTAGE MANAGEMENT

(71) Applicant: QUALCOMM Incorporated, San Diego, CA (US)

(72) Inventors: Vijayakumar Ashok DIBBAD, Bangalore (IN); Mahadevamurty NEMANI, San Diego, CA (US); Sibasish DAS, San Diego, CA (US); Nikhil Ashok BHELAVE, Gondiya (IN)

(21) Appl. No.: 18/657,592

(22) Filed: May 7, 2024

(51) Int. Cl. G05F 1/575

(52) U.S. Cl. CPC G05F 1/575

(57) ABSTRACT

A method for control loop sub-system voltage management is described. The method includes detecting a requested dynamic clock voltage scaling (DCVS) operating voltage in a predetermined voltage range. The method also includes setting a current sink/source drive of a system-on-chip (SoC) according to the requested DCVS operating voltage. The method further includes adjusting an output voltage of a voltage regulator through a voltage regulator feedback path between the voltage regulator and the current sink/source drive of the SoC.

### BACKGROUND

### Field of the Disclosure

Aspects of the present disclosure relate to clock monitoring units of integrated circuits (ICs) and more specifically to a control loop for sub-system voltage management.

### Background

Stringent electrical operational specifications help address system redundancy, provide greater resistance to electrical and software faults, and improve system monitoring. One sub-component of such systems that is of interest is a voltage regulator that produces voltages, also commonly referred to as an operating voltage (VOP) to drive various sub-systems of an integrated circuit (IC) or system-on-chip (SoC). Reduced latency for managing voltage regulator outputs (e.g., VOP) as well as power optimization for battery operated designs are desired sub-system voltage management power optimizations. Additionally, reduced latency in managing the output voltage (e.g., VOP) of the voltage regulator improves a thermal profile management of the SoC. A control loop for sub-system voltage management is desired.

### SUMMARY

A method for control loop sub-system voltage management is described. The method includes detecting a requested dynamic clock voltage scaling (DCVS) operating voltage in a predetermined voltage range. The method also includes setting a current sink/source drive of a system-on-chip (SoC) according to the requested DCVS operating voltage. The method further includes adjusting an output voltage of a voltage regulator through a voltage regulator feedback path between the voltage regulator and the current sink/source drive of the SoC.

A control loop sub-system voltage management system is described. The system includes a system-on-chip (SoC) comprising a current sink/source drive operable according to a requested dynamic clock voltage scaling (DCVS) operating voltage in a predetermined voltage range. The system also includes a voltage regulator. The system further includes a voltage regulator feedback path between the voltage regulator and the current sink/source drive of the SoC to adjust an output voltage of the voltage regulator.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for control loop sub-system voltage management, in accordance with various aspects of the present disclosure.

FIG. 2 is a block diagram illustrating a control loop sub-system voltage management system, in accordance with various aspects of the present disclosure.

FIG. 3 is a block diagram illustrating a control loop sub-system voltage management system, in accordance with various aspects of the present disclosure.

FIG. 4 is a process flow diagram illustrating a method for operating a control loop sub-system voltage management system, according to various aspects of the present disclosure.

FIG. 5 is a process flow diagram illustrating a method for control loop sub-system voltage management, according to various aspects of the present disclosure.

FIG. 6 is a block diagram showing an exemplary wireless communications system in which a configuration of the disclosure may be advantageously employed.

FIG. 7 is a block diagram illustrating a design workstation used for circuit, layout, and logic design of a semiconductor component according to one configuration.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations.

Electronic circuits designed for safety-related applications may be prescribed with more stringent specifications. These stringent specifications are prescribed because faults in safety-related applications (e.g., automotive control circuits) may result in severe injury or death to humans. There are governmental organizations that prescribe the specifications of electronic circuits for safety-related applications, including the International Organization for Standardization (ISO) and the International Electrotechnical Commission (IEC), which provide specifications that state certain safety-related systems be continuously monitored during runtime to ensure proper operations.

This continuous monitoring specification also includes continuously monitoring the operating voltages (VOPs) that drive the sub-systems of a system-on-chip (SoC) used in safety-related systems. Sub-systems (SS) of an SoC rely on an interface to dynamically adapt the VOP supplied by a voltage regulator under the control of a power management integrated circuit (PMIC). Reduced latency for managing voltage regulator outputs (e.g., VOP) as well as power optimization for battery operated designs are desired sub-system voltage management power optimizations. Additionally, reduced latency in managing the output voltage (e.g., VOP) of the voltage regulator improves a thermal profile management of the SoC.

Unfortunately, an existing path for issuing dynamic VOP requests from the sub-systems of the SoC to the PMIC incur substantial latencies in performing voltage scaling. These existing voltage scaling latencies prohibit load profile aware driving of the VOP from the sub-systems of the SoC. In operation, most available periods for VOP scaling are lost despite the sub-system's desire to drive a load profile aware VOP. For example, assume the sub-system desires to optimize VOP for a known load profile for a period. Due to a control loop latency for a voltage decrease/increase, the sub-system is provided with insufficient time for driving an optimal VOP because an optimal VOP window opportunity is lost. A control loop for sub-system voltage management is desired.

Various aspects of the present disclosure are directed to a control loop for sub-system voltage management to support dynamic VOP scaling. According to various aspects of the present disclosure, a method for control loop sub-system voltage management is described. The method includes detecting a requested dynamic clock voltage scaling (DCVS) operating voltage in a predetermined voltage range. The method also includes setting a current sink/source drive of a system-on-chip (SoC) according to the requested DCVS operating voltage. The method further includes adjusting an output voltage of a voltage regulator through a voltage regulator feedback path between the voltage regular and the current sink/source drive of the system-on-chip (SoC).

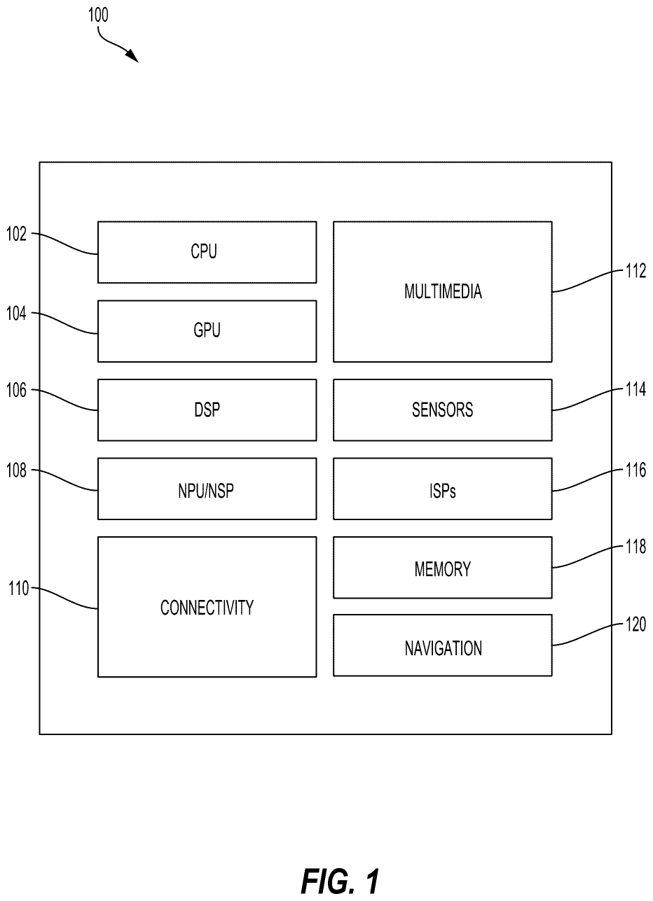

FIG. 1 illustrates an example implementation of a system-on-chip (SoC) 100, which is configured for control loop sub-system voltage management, in accordance with various aspects of the present disclosure. The SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the SoC 100 includes various processing units that support multi-threaded operation. For the configuration shown in FIG. 1, the SoC 100 includes a multi-core central processing unit (CPU) 102, a graphics processor unit (GPU) 104, a digital signal processor (DSP) 106, and a neural processor unit (NPU)/neural signal processor (NSP) 108. The SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU/NSP 108 may be based on an ARM instruction set.

Sub-systems of the SoC 100 rely on an interface to dynamically adapt an operating voltage (VOP) supplied by a voltage regulator under the control of a power management integrated circuit (PMIC). Unfortunately, an existing path for issuing dynamic VOP requests from the sub-systems of the SoC 100 to the PMIC incur substantial latencies. In particular, the existing path for issuing dynamic VOP requests suffers from serialized path latencies due to shared resources. Additionally, an increasing number of rails for supporting new PMIC features are further impacting dynamic VOP requests. These existing voltage scaling latencies prohibit load profile aware driving of the VOP from the sub-systems of the SoC 100. In operation, many opportune periods for optimal VOP are lost despite the sub-system's desire to drive a load profile aware VOP. For example, assume the sub-system desires to optimize VOP for a known load profile for a period (e.g., 50 microseconds (μs)). Due to round loop latency (e.g., 30 μs) for a voltage decrease and a voltage increase (e.g., 30 μs), the sub-system is not provided with sufficient time for driving an optimal VOP because an optimal VOP window opportunity is lost.

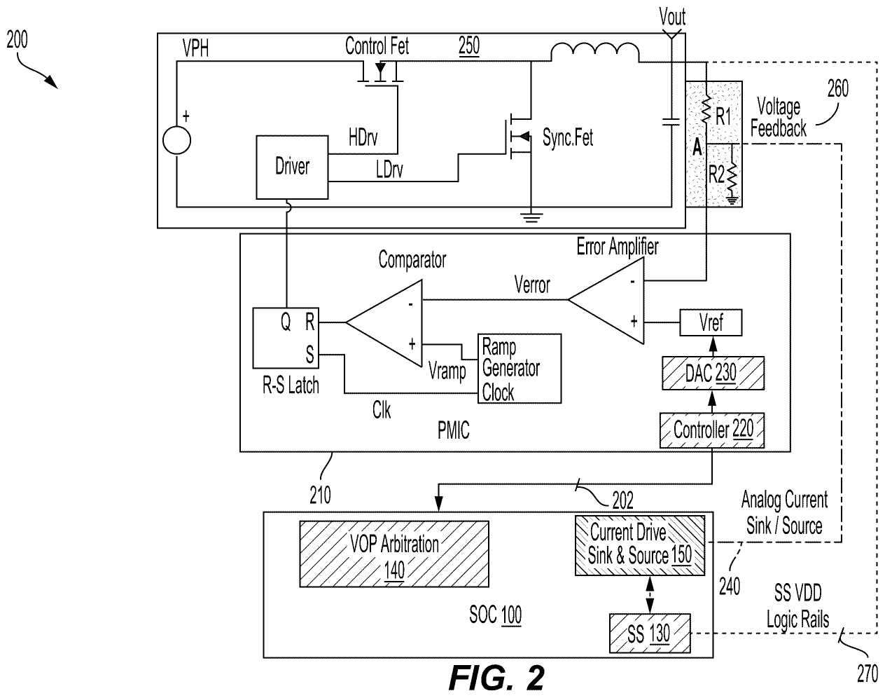

FIG. 2 is a block diagram illustrating a control loop sub-system voltage management system 200, in accordance with various aspects of the present disclosure. As shown in FIG. 2, the control loop sub-system voltage management system 200 is configured for control loop sub-system voltage management of operating voltages for sub-systems (SS) 130 of the SoC 100, in accordance with various aspects of the present disclosure. The SoC 100 may be used in a safety-related system. The SoC 100 may include a set of sub-systems 130 to perform various operations in accordance with the design specification for the SoC 100.

In various aspects of the present disclosure, sub-systems 130 of the SoC 100 rely on an interface to dynamically adapt an operating voltage (VOP) supplied by a voltage regulator (VR) 250 under the control of a power management integrated circuit (PMIC) 210. In operation, the voltage regulator 250 receives an output voltage for an inverter (VPH). During conventional operation, an existing path for issuing dynamic VOP requests from the sub-systems 130 of the SoC 100 to the PMIC incur substantial latencies. In particular, the existing path for issuing dynamic VOP requests suffers from serialized path latencies due to a VOP arbitration block 140 for voting on the VOP. The serial path latencies further include communication of the selected VOP over an interface 202 to a controller 220 of the PMIC 210 as well as a digital-to-analog (DAC) block conversion 230, followed by an acknowledgement from the PMIC 210 to the VOP arbitration block 140.

According to various aspects of the present disclosure, the SoC 100 includes a current drive 150 configured to drive a sink/source current 240 to/from a node A resistor voltage divider using a voltage feedback path 260. In this example, the sub-systems 130 operate the current drive 150 to drive the sink/source current 240 using the voltage feedback path 260 to the node A resistor voltage divider for dynamically scaling the VOP supplied at an output voltage (Vout) of the voltage regulator 250. In this example, the output voltage Vout is supplied to the sub-systems 130 through power rails 270 for operating the sub-systems 130 according to the supplied VOP based on a reference voltage (Vref). According to various aspects of the present disclosure, the node A voltage is dynamically adjusted according to Equation (1):

$$Vout = Vref ( 1 + \frac{R 1}{R 2} ) \qquad ( 1 )$$

In operation, the voltage feedback path 260 is utilized to change the VOP through the current drive 150 that is controlled by the sub-systems 130 without any dependency on digital resources or interfaces. For example, to increase the Vout supplied by the power rails 270, the sub-systems 130 set a sink current (i_Sink) of the current drive 150, which reduces the node A voltage. In this example, the voltage regulator 250 increases Vout to regulate back the node A voltage to Vref according to Equation (2):

$$New Vout = Vref + ( \vert i\_Sink \vert * R 2 ) . \qquad ( 2 )$$

To decrease Vout, the sub-systems 130 set a source current (i_Source) of the current drive 150, which increases the node A voltage. In this example, the voltage regulator 250 decreases Vout to regulate back the node A voltage to Vref according to Equation (3):

$$New Vout = Vref - ( \vert i\_Source \vert * R 2 ) . \qquad ( 3 )$$

In various aspects of the present disclosure, a feedback configuration to configure the current drive 150 for driving the sink/source current 240 to/from the node A voltage using the voltage feedback path 260 may be performed as shown in Table 1.

TABLE 1
Feedback Configuration

| | |
|---|---|
| R1 | 200 kΩ |
| R2 | 400 kΩ |
| Vref | 0.4 V |
| $Iref [ Current through R 1 ] = \frac{{V}_{ref}}{R 2}$ | = 1 μA |
| $Vout = Vref ( 1 + \frac{R 1}{R 2} )$ | 0.6 V |

Table 1 illustrates sample resistance values for R1 (e.g., 200 kiloohms (k Ω)) and R2 (e.g., 400 kΩ) as well as Vref (e.g., 0.4 volts (V)). Based on these sample values, a current through R1 (Iref=Vref/R2) is approximately one (1) microamp (μA), the output voltage Vout is equal to 0.6 V. According to various aspects of the present disclosure, the output voltage Vout is dynamically adjusted to provide a desired VOP to the sub-systems 130, as shown in Tables 2 and 3.

TABLE 2

| Sink Current from Feedback Path to Increase Vout. | | |
|---|---|---|
| Current Drive | Decrease in Vfb (mV) | Vout |
| 0 | 0.000 | 0.600 |
| −40 nA | −0.016 (−40 nA*R2) | 0.616 |
| −80 nA | −0.032 | 0.632 |
| −200 nA | −0.080 | 0.680 |
| −400 nA | −0.160 | 0.760 |

TABLE 3

| Source Current into Feedback Path to Decrease Vout. | | |
|---|---|---|
| Current Drive | Increase in Vfb (mV) | Vout |
| 0 | 0.000 | 0.600 |
| 40 nA | 0.016 (40 nA*R2) | 0.584 |
| 80 nA | 0.032 | 0.568 |
| 200 nA | 0.080 | 0.520 |
| 400 nA | 0.160 | 0.440 |

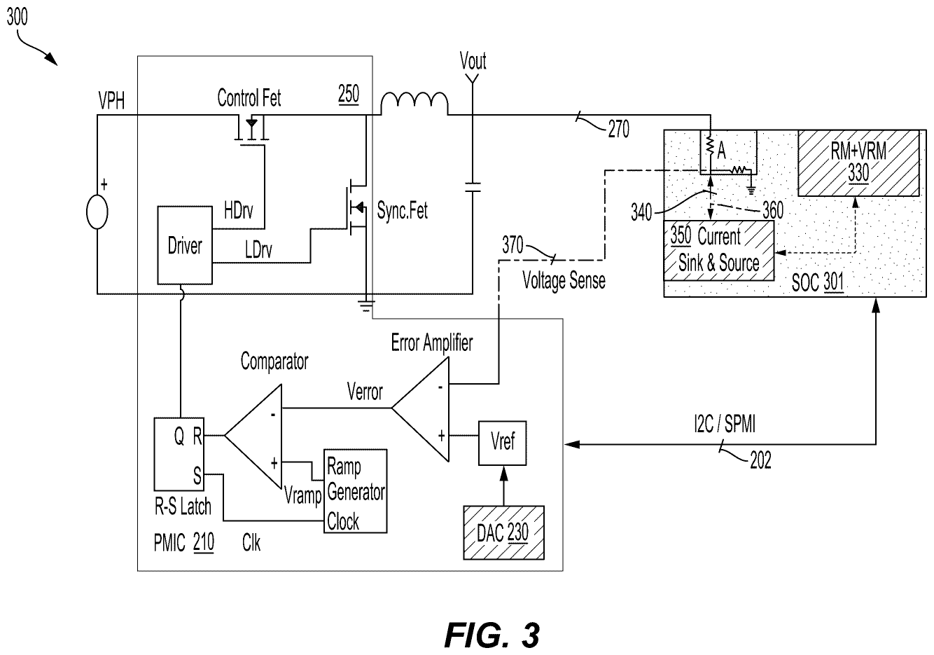

In this example, Tables 2 and 3 include a current drive column, a feedback voltage (Vfb) column, and a Vout column. As shown in Table 2, the current drive column refers to a negative sink current (e.g., −40 nanoamperes (nA) to −400 nA) from the voltage feedback path to decrease the feedback voltage Vfb and increase the output voltage Vout. As shown in Table 3, the current drive column refers to a positive source current (e.g., 40 nA to 400 nA) through the voltage feedback path to increase the feedback voltage Vfb and decrease the output voltage Vout. Although a proposed dynamic clock voltage scaling (DCVS) scheme of the control loop sub-system voltage management system 200 involves per rail control, implementation of the proposed DCVS scheme involves the addition of a single pin on the SoC 100 and does not specify a pin addition to the PMIC 210. Additionally, for die level voltage feedback sensing, a proposed solution that avoids the added cost of a pin on the SoC 100 may be provided as shown in FIG. 3.

FIG. 3 is a block diagram illustrating a control loop sub-system voltage management system 300, in accordance with various aspects of the present disclosure. As shown in FIG. 3, the control loop sub-system voltage management system 300 is configured to provide control loop sub-system voltage management of operating voltages (VOPs) for sub-systems (SS) 330 of an SoC 301, in accordance with various aspects of the present disclosure. The SoC 301 may be used in a safety-related system. The SoC 301 may include a set of sub-systems 330 to perform various operations in accordance with the design specification for the SoC 301 and is shown to include a regulator module (RM) and a voltage regulator module (VRM). The control loop sub-system voltage management system 300 is described using similar reference numbers to the control loop sub-system voltage management system 200 shown in FIG. 2.

In various aspects of the present disclosure, sub-systems 330 of the SoC 301 dynamically adapt an operating voltage (VOP) supplied by a voltage regulator 250 under the control of the PMIC 210. According to various aspects of the present disclosure, the SoC 301 includes a current drive 350 configured to drive a sink/source current 340 to/from a node A voltage using a voltage feedback path 360. In this example, the sub-systems 330 operate the current drive 350 to drive the sink/source current 340 using the voltage feedback path 360 to the node A for dynamically scaling the VOP supplied at an output voltage (Vout) of the voltage regulator 250.

In this example, the output voltage Vout is supplied to the SoC 301 through power rails 270 for operating the sub-systems 330 according to the supplied VOP based on a reference voltage (Vref). According to various aspects of the present disclosure, the node A voltage dynamically adjusts according to Equation (1). According to various aspects of the present disclosure, the control loop sub-system voltage management system 300 utilizes die level voltage feedback sensing by incorporating the node A. Beneficially, the control loop sub-system voltage management system 300 avoids the added cost of a pin specified by the control loop sub-system voltage management system 200, as shown in FIG. 2.

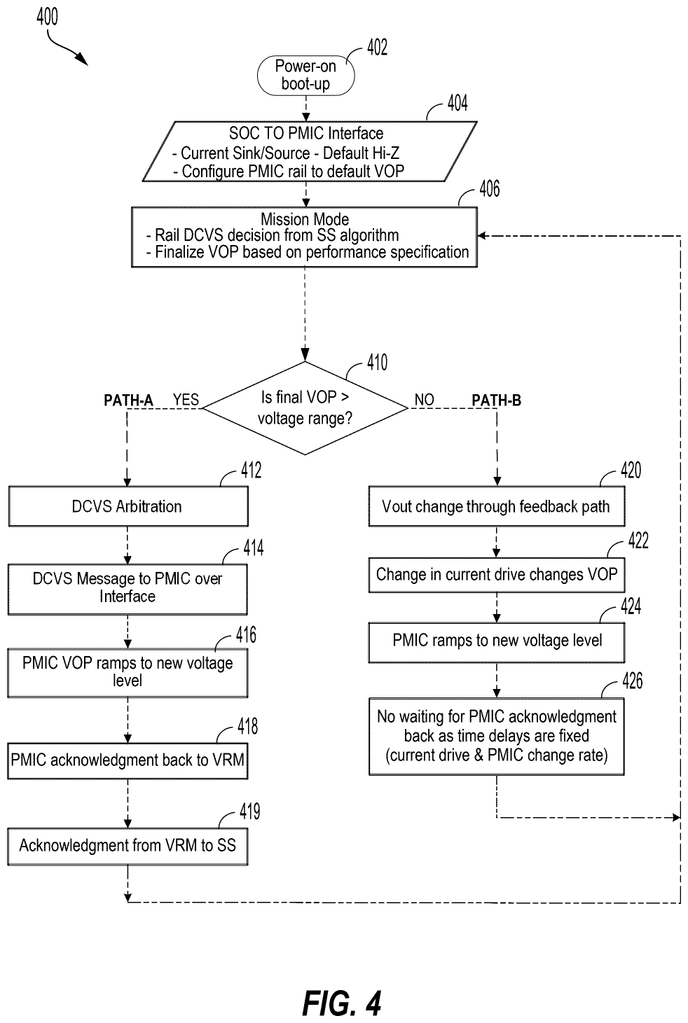

FIG. 4 is a process flow diagram illustrating a method 400 for operating a control loop sub-system voltage management system, according to various aspects of the present disclosure. The method 400 begins at block 402, with a power-on boot-up of a system-on-chip (SoC). At block 404, a current sink/source drive of the SoC is set to a default high impedance (Hi-Z). Additionally, a PMIC voltage rail is set to a default VOP. At block 406, a mission mode is performed, in which a final VOP is selected based on a performance specification and a DCVS decision from the SoC sub-systems.

At block 410, the final VOP is compared to a voltage range. When the final VOP is greater than the voltage range, a PATH-A is followed. Otherwise, a PATH-B is followed. As shown in blocks 412 to 419, PATH-A involves additional latency due to DCVS arbitration at block 412, communication with the PMIC at block 414, PMIC VOP ramp-up at block 416, PMIC acknowledgment to a voltage regulator module (VRM) at block 418, and acknowledgment from the VRM to the SoC sub-systems at block 419.

According to various aspects of the present disclosure, the PATH-B provides a significantly reduced latency relative to the DCVS schemes described in blocks 412 to 419. At block 420, a voltage regulator output voltage (Vout) dynamically adjusts beginning at block 422. At block 422, a current drive is modified to change the VOP. At block 424, the current drive causes ramp-up/ramp-down of the PMIC depending on the change in the current drive. The dynamic adjustment of the VOP is completed at block 426, without incurring a delay for waiting from a PMIC acknowledgement, as a time delay is fixed.

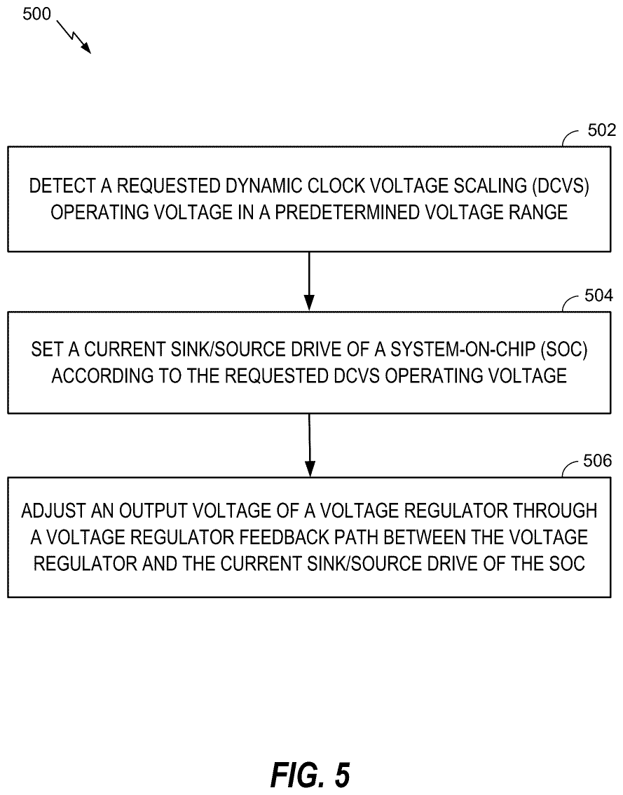

According to various aspects of the present disclosure, the proposed DCVS scheme of PATH-B provides a significantly reduced latency relative to the DCVS scheme of PATH-A. In particular, the proposed DCVS scheme utilizes a regulator feedback path to change a sub-system operating voltage (VOP) through a current sink/source drive controlled by the SoC sub-systems without any dependency on digital resources or interfaces. Additionally, hardware specifications of architecture features are improved as a voltage change over PATH-B is deterministic in time (see block 426). Although the proposed DCVS scheme involves per rail control, implementation of the proposed DCVS scheme involves the addition of a single pin on the SoC and does not specify a pin addition on the PMIC, as shown in FIG. 2. Additionally, for die level voltage feedback sensing, the proposed solution does not involve the added cost of a pin on the SoC, as shown in FIG. 3. The proposed DCVS scheme beneficially provides a significant latency reduction (e.g., approximately 75%) relative to an existing solution, for example, as described in the process of FIG. 5.

FIG. 5 is a process flow diagram illustrating a method for control loop sub-system voltage management, according to various aspects of the present disclosure. A method 500 begins at block 502, in which a requested dynamic clock voltage scaling (DCVS) operating voltage is detected in a predetermined voltage range. At block 504, a current sink/source drive of a system-on-chip (SoC) is set according to the requested DCVS operating voltage. At block 506, an output voltage of a voltage regulator is adjusted through a voltage regulator feedback path between the voltage regulator and the current sink/source drive of the SoC. For example, as shown in FIG. 2, the sub-systems 130 operate the current drive 150 to drive the sink/source current 240 using the voltage feedback path 260 to the node A resistor voltage divider for dynamically scaling the VOP supplied at an output voltage (Vout) of the voltage regulator 250.

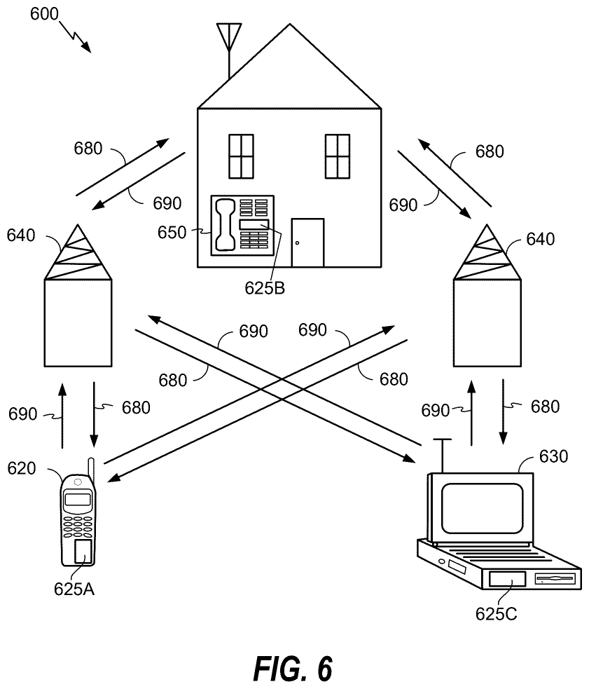

FIG. 6 is a block diagram showing an exemplary wireless communications system 600 in which an aspect of the present disclosure may be advantageously employed. For purposes of illustration, FIG. 6 shows three remote units 620, 630, and 650 and two base stations 640. It will be recognized that wireless communications systems may have many more remote units and base stations. Remote units 620, 630, and 650 include integrated circuit (IC) devices 625A, 625C, and 625B that include the disclosed control loop sub-system voltage management system. It will be recognized that other devices may also include the dynamic clock voltage scaling architecture, such as the base stations 640, switching devices, and network equipment. FIG. 6 shows forward link signals 680 from the base stations 640 to the remote units 620, 630, and 650, and reverse link signals 690 from the remote units 620, 630, and 650 to the base stations 640.

In FIG. 6, remote unit 620 is shown as a mobile telephone, remote unit 630 is shown as a portable computer, and remote unit 650 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a communications device, personal digital assistant (PDA), a fixed location data unit, such as meter reading equipment, or other device that stores or retrieves data or computer instructions, or combinations thereof. Although FIG. 6 illustrates remote units according to the aspects of the present disclosure, the present disclosure is not limited to these exemplary illustrated units. Aspects of the present disclosure may be suitably employed in many devices, which include the disclosed control loop sub-system voltage management system.

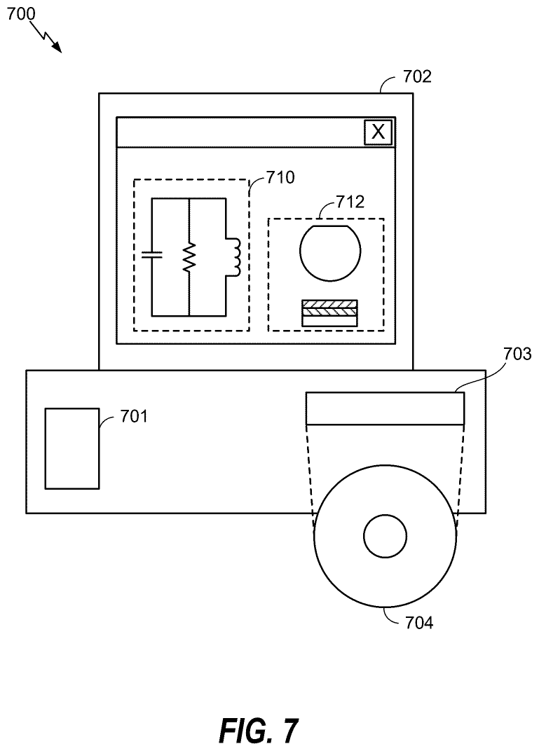

FIG. 7 is a block diagram illustrating a design workstation used for circuit, layout, and logic design of a semiconductor component, such as the control loop sub-system voltage management system disclosed above. A design workstation 700 includes a hard disk 701 containing operating system software, support files, and design software such as Cadence or OrCAD. The design workstation 700 also includes a display 702 to facilitate design of a circuit 710, such as a control loop sub-system voltage management system. A storage medium 704 is provided for tangibly storing the design of the circuit 710 (e.g., the control loop sub-system voltage management system). The design of the circuit 710 or the DCVS component 712 may be stored on the storage medium 704 in a file format such as GDSII or GERBER. The storage medium 704 may be a compact disc read-only memory (CD-ROM), digital versatile disc (DVD), hard disk, flash memory, or another appropriate device. Furthermore, the design workstation 700 includes a drive apparatus 703 for accepting input from or writing output to the storage medium 704.

Data recorded on the storage medium 704 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 704 facilitates the design of the circuit 710 or the DCVS component 712 by decreasing the number of processes for designing semiconductor wafers.

Implementation examples are described in the following numbered clauses:
1. A method for control loop sub-system voltage management, the method comprising:
   detecting a requested dynamic clock voltage scaling (DCVS) operating voltage in a predetermined voltage range;
   setting a current sink/source drive of a system-on-chip (SoC) according to the requested DCVS operating voltage; and
   adjusting an output voltage of a voltage regulator through a voltage regulator feedback path between the voltage regulator and the current sink/source drive of the SoC.
2. The method of clause 1, in which setting comprises drawing a sink current from the voltage regulator feedback path between the voltage regulator and the current sink/source drive of the SoC to increase the output voltage.
3. The method of any of clauses 1 or 2, in which setting comprises driving a source current through the voltage regulator feedback path between the voltage regulator and the current sink/source drive of the SoC to decrease the output voltage.
4. The method of any of clauses 1-3, in which adjusting the output voltage comprises controlling a feedback voltage on the voltage regulator feedback path to scale the output voltage.
5. The method of clause 4, in which controlling the feedback voltage comprises dynamically adjusting a resistor voltage divider on the voltage regulator feedback path.
6. The method of clause 5, in which dynamically adjusting comprises driving a sink/source current to/from the resistor voltage divider to tune the output voltage.
7. The method of clause 5, in which the resistor voltage divider is integrated with the SoC.
8. The method of clause 5, in which the resistor voltage divider is integrated with the voltage regulator.
9. The method of any of clauses 1-8, in which the current sink/source drive is controlled by sub-systems (SS) of the SoC.
10. The method of any of clauses 1-8, in which the current sink/source drive is controlled by a voltage regulator module of the SoC.
11. A control loop sub-system voltage management system, comprising:
   a system-on-chip (SoC) comprising a current sink/source drive operable according to a requested dynamic clock voltage scaling (DCVS) operating voltage in a predetermined voltage range;
   a voltage regulator; and
   a voltage regulator feedback path between the voltage regulator and the current sink/source drive of the SoC to adjust an output voltage of the voltage regulator.
12. The system of clause 11, in which the current sink/source drive is further operable to draw a sink current from the voltage regulator feedback path between the voltage regulator and the current sink/source drive of the SoC to increase the output voltage.
13. The system of any of clauses 11 or 12, in which the current sink/source drive is further operable to drive a source current through the voltage regulator feedback path between the voltage regulator and the current sink/source drive of the SoC to decrease the output voltage.
14. The system of any of clauses 11-13, further comprising a resistor voltage divider coupled between the voltage regulator feedback path and the output voltage.
15. The system of clause 14, in which the resistor voltage divider is configured to control a feedback voltage on the voltage regulator feedback path and scale the output voltage.
16. The system of clause 14, in which the current sink/source drive is further operable to drive a sink/source current to/from the resistor voltage divider to tune the output voltage.
17. The system of clause 14, in which the resistor voltage divider is integrated with the SoC.
18. The system of clause 14, in which the resistor voltage divider is integrated with the voltage regulator.
19. The system of any of clauses 11-18, in which the SoC further comprises sub-systems (SS) operable to control the current sink/source drive.
20. The system of any of clauses 11-18, in which the SoC further comprises a voltage regulator module operable to control the current sink/source drive.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable programmable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform substantially the same function, or achieve substantially the same result as the corresponding configurations described herein, may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in random access memory (RAM), flash memory, read-only memory (ROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general-purpose or special-purpose computer. By way of example, and not limitation, such computer-readable media can include random access memory (RAM), read-only memory (ROM), electrically erasable programmable read-only memory (EEPROM), compact disc read-only memory (CD-ROM) or other optical disk storage, magnetic disk storage or other magnetic storage devices, or any other medium that can be used to carry or store specified program code means in the form of instructions or data structures and that can be accessed by a general-purpose or special-purpose computer, or a general-purpose or special-purpose processor. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

The previous description of the present disclosure is provided to enable any person skilled in the art to make or use the disclosure. Various modifications to the present disclosure will be readily apparent to those skilled in the art, and the generic principles defined herein may be applied to other variations without departing from the spirit or scope of the disclosure. Thus, the present disclosure is not intended to be limited to the examples and designs described herein but is to be accorded the widest scope consistent with the principles and novel features disclosed herein.

What is claimed:

1. A method for control loop sub-system voltage management, the method comprising:
detecting a requested dynamic clock voltage scaling (DCVS) operating voltage in a predetermined voltage range;
setting a current sink/source drive of a system-on-chip (SoC) according to the requested DCVS operating voltage; and
adjusting an output voltage of a voltage regulator through a voltage regulator feedback path between the voltage regulator and the current sink/source drive of the SoC.

2. The method of claim 1, in which setting comprises drawing a sink current from the voltage regulator feedback path between the voltage regulator and the current sink/source drive of the SoC to increase the output voltage.

3. The method of claim 1, in which setting comprises driving a source current through the voltage regulator feedback path between the voltage regulator and the current sink/source drive of the SoC to decrease the output voltage.

4. The method of claim 1, in which adjusting the output voltage comprises controlling a feedback voltage on the voltage regulator feedback path to scale the output voltage.

5. The method of claim 4, in which controlling the feedback voltage comprises dynamically adjusting a resistor voltage divider on the voltage regulator feedback path.

6. The method of claim 5, in which dynamically adjusting comprises driving a sink/source current to/from the resistor voltage divider to tune the output voltage.

7. The method of claim 5, in which the resistor voltage divider is integrated with the SoC.

8. The method of claim 5, in which the resistor voltage divider is integrated with the voltage regulator.

9. The method of claim 1, in which the current sink/source drive is controlled by sub-systems (SS) of the SoC.

10. The method of claim 1, in which the current sink/source drive is controlled by a voltage regulator module of the SoC.

11. A control loop sub-system voltage management system, comprising:
a system-on-chip (SoC) comprising a current sink/source drive operable according to a requested dynamic clock voltage scaling (DCVS) operating voltage in a predetermined voltage range;
a voltage regulator; and
a voltage regulator feedback path between the voltage regulator and the current sink/source drive of the SoC to adjust an output voltage of the voltage regulator.

12. The system of claim 11, in which the current sink/source drive is further operable to draw a sink current from the voltage regulator feedback path between the voltage regulator and the current sink/source drive of the SoC to increase the output voltage.

13. The system of claim 11, in which the current sink/source drive is further operable to drive a source current through the voltage regulator feedback path between the voltage regulator and the current sink/source drive of the SoC to decrease the output voltage.

14. The system of claim 11, further comprising a resistor voltage divider coupled between the voltage regulator feedback path and the output voltage.

15. The system of claim 14, in which the resistor voltage divider is configured to control a feedback voltage on the voltage regulator feedback path and scale the output voltage.

16. The system of claim 14, in which the current sink/source drive is further operable to drive a sink/source current to/from the resistor voltage divider to tune the output voltage.

17. The system of claim 14, in which the resistor voltage divider is integrated with the SoC.

18. The system of claim 14, in which the resistor voltage divider is integrated with the voltage regulator.

19. The system of claim 11, in which the SoC further comprises sub-systems (SS) operable to control the current sink/source drive.

20. The system of claim 11, in which the SoC further comprises a voltage regulator module operable to control the current sink/source drive.
